(19) United States
(12) Patent Application Publication
(10) Pub. No.: US 2010/0015329 A1
(43) Pub. Date: Jan. 21, 2010

(54) METHODS AND SYSTEMS FOR PACKAGING INTEGRATED CIRCUITS WITH THIN METAL CONTACTS

(75) Inventors: Luu T. NGUYEN, San Jose, CA (US); Anindya PODDAR, Sunnyvale, CA (US); Shaw W. LEE, Cupertino, CA (US); Ashok S. PRABHU, San Jose, CA (US)

Correspondence Address: Beyer Law Group LLP/ NSC, P.O.Box 1687, Cupertino, CA, 95015-1687, US

(73) Assignee: National Semiconductor Corporation, Santa Clara, CA (US)

(21) Appl. No.: 12/174,046

(22) Filed: Jul. 16, 2008

(51) Int. Cl. B05D 5/12; B05D 3/06; C23C 18/16

(52) U.S. Cl. 427/96.2; 427/98.4; 205/183; 427/555

(57) ABSTRACT

Methods and arrangements are described for forming an array of contacts for use in packaging one or more integrated circuit devices. In particular, various methods are described for forming contacts having thicknesses less than approximately 10 μm, and in particular embodiments, between 0.5 to 2 μm.

### TECHNICAL FIELD

The present invention relates generally to the packaging of integrated circuits (ICs). More particularly, the invention relates to packaging methods and arrangements involving thin metallic interconnect structures.

### BACKGROUND

There are a number of conventional processes for packaging integrated circuit (IC) dice. By way of example, many IC packages utilize a metallic leadframe that has been stamped or etched from a metal sheet to provide electrical interconnects to external devices. The die may be electrically connected to the leadframe by means of bonding wires, solder bumps or other suitable electrical connections. In general, the die and portions of the leadframe are encapsulated with a molding material to protect the delicate electrical components on the active side of the die while leaving selected portions of the leadframe exposed to facilitate electrical connections to external devices.

Many conventional stamped or etched leadframes have a thickness that may range from approximately 100-300 μm (4-12 mils). Further reducing the thickness of the leadframe may offer several benefits, including a reduction in package size and the conservation of leadframe metal, which lowers production costs. In some package formats, however, a thinner leadframe has a greater propensity to warp during the packaging process. By way of example, warping may be particularly problematic in leadless leadframe package (LLP) and quad flatpack no-lead (QFN) package formats. A supporting structure, such as backing tape, may be applied to the leadframe to reduce the risk of warpage. Such structures, however, may entail higher costs among other problems.

Although existing techniques for fabricating leadframes and for packaging integrated circuits using leadframe technology work well, there are continuing efforts to develop even more efficient designs and methods for packaging integrated circuits.

### SUMMARY

The claimed invention relates to methods and arrangements for forming an array of contacts for use in packaging one or more integrated circuit devices. In one aspect of the present invention, a primer is deposited onto a substrate such that first areas on the substrate are not covered by the primer. These first areas not covered by the primer form at least a first pattern. In various embodiments, the pattern may resemble a leadframe panel pattern including at least one array of device areas. Each device area, in turn, may be patterned into a leadless leadframe type pattern having an array of contacts. In a particular embodiment, the primer is printed onto the substrate. To facilitate printing, the substrate may be formed of a flexible material and rolled onto a reel. The printing may then be accomplished in a reel-to-reel or strip-to-strip process. After the primer is deposited over the substrate, a base metal layer is then sputtered or otherwise deposited over the substrate. The primer may then be removed such that first portions of the base metal layer that are deposited over the first areas of the substrate that are not deposited over primer are not removed with the primer and remain affixed with the substrate thereby forming an array of contacts. In a particular embodiment, the primer is water-soluble and the solvent comprises water or suitable solvent media. In contrast, second portions of the base metal layer and any other portions of material that are deposited over primer are removed with the primer. The resulting array of contacts may be formed with a thickness less than approximately 10 μm, and in particular embodiments, between 0.5 to 2 μm.

In some embodiments, the substrate is then cut into panels. Each panel may have a conventional leadframe panel footprint and include at least one array of devices areas. Integrated circuit dice may then be attached and electrically connected to the at least one array of device areas such that each die is positioned within an associated device area. In various embodiments, the at least one array of device areas may then be encapsulated at the panel level with molding material. The substrate may then be removed while leaving at least the base metal layer affixed with the molding material thereby leaving at least bottom surfaces of the contacts exposed. Each encapsulated array of device areas may then be singulated to provide a multiplicity of individual integrated circuit packages.

In another aspect of the invention, another method for forming an array of contacts for one or more integrated circuit devices is described. In various embodiments, a base metal layer is deposited over a substrate. In contrast to the aforementioned process, no primer is patterned over the substrate. In a particular embodiment, the base metal layer is deposited through a mask such that the resultant base metal layer forms a leadframe type pattern or other interconnect pattern. The base metal layer may either be a single metal layer (e.g., Cu) or a metal stack including base and barrier layers. The base metal layer may be sputtered onto the substrate, and in some embodiments, may have a thickness in the range of approximately 0.1 to 0.3 μm, although both thinner and thicker base metal layers may be desirable in various alternate embodiments.

The features of the interconnect pattern formed with the base layer are then sharpened using a laser ablation process. The use of laser ablation to sharpen the geometries of the interconnect pattern allows for the formation of very fine features and pitches. Furthermore, even finer features and pitches (e.g., ≦10 μm) may be produced by depositing the base metal layer without the use of a mask. In these embodiments, laser ablation alone may be used to form the interconnect pattern. After the interconnect pattern is defined, the thickness of the base metal layer may be increased and the process may then proceed as described above.

Variations and features of one or more of the foregoing embodiments can be included in another embodiment, and additional variations and features can be used in any one of the foregoing embodiments, as may be desired.

Other apparatuses, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention and the advantages thereof, may best be understood by reference to the following description taken in conjunction with the accompanying drawings in which:

FIG. 1A is a diagrammatic top view of a substrate having an interconnect pattern thereon including a multiplicity of device areas arranged into a plurality of panels in accordance with one embodiment of the present invention.

FIG. 1B is an enlarged diagrammatic top view of one of the panels illustrated in FIG. 1A.

FIG. 1C is an enlarged diagrammatic top view of one of the device areas on the panel illustrated in FIG. 1B.

FIG. 2 is a flow chart illustrating a process for forming an interconnect pattern on a substrate for use in packaging integrated circuit devices in accordance with one embodiment of the present invention.

FIGS. 3A-3K are diagrammatic side views of various stages of a packaging process in accordance with one embodiment of the present invention.

FIG. 4 illustrates a reel-to-reel printing process.

FIG. 5 is a flow chart illustrating a process for packaging integrated circuit devices in accordance with one embodiment of the present invention.

FIG. 6A illustrates in top plan view a substrate having been processed into an exemplary molded strip having integrated circuit devices and a molded cap formed thereupon according to one embodiment of the present invention.

FIG. 6B illustrates in side elevation view the molded strip of FIG. 6A according to one embodiment of the present invention.

FIG. 7A illustrates in side elevation view the molded strip of FIG. 6B having the substrate being removed according to one embodiment of the present invention.

FIG. 7B illustrates in bottom plan view the molded strip of FIG. 6A with the substrate removed and the electrical interconnect patterns exposed thereby according to one embodiment of the present invention.

FIG. 8 is a flow chart illustrating another process for forming an interconnect pattern on a substrate for use in packaging integrated circuit devices in accordance with another embodiment of the present invention.

In the drawings, like reference numerals are sometimes used to designate like structural elements. It should also be appreciated that the depictions in the figures are diagrammatic and not to scale.

### DETAILED DESCRIPTION OF EXAMPLE EMBODIMENTS

The present invention relates generally to the packaging of integrated circuits. More particularly, the invention relates to packaging methods and arrangements involving thin metallic interconnect structures.

Example applications of apparatuses and methods according to the present invention are described in this section. These examples are being provided solely to add context and aid in the understanding of the invention. It will thus be apparent to one skilled in the art that the present invention may be practiced without some or all of these specific details. In other instances, well known process steps have not been described in detail in order to avoid unnecessarily obscuring the present invention. Other applications are possible such that the following examples should not be taken as limiting.

In the following detailed description, references are made to the accompanying drawings, which form a part of the description and in which are shown, by way of illustration, specific embodiments of the present invention. Although these embodiments are described in sufficient detail to enable one skilled in the art to practice the invention, it is understood that these examples are not limiting; such that other embodiments may be used, and changes may be made without departing from the spirit and scope of the invention.

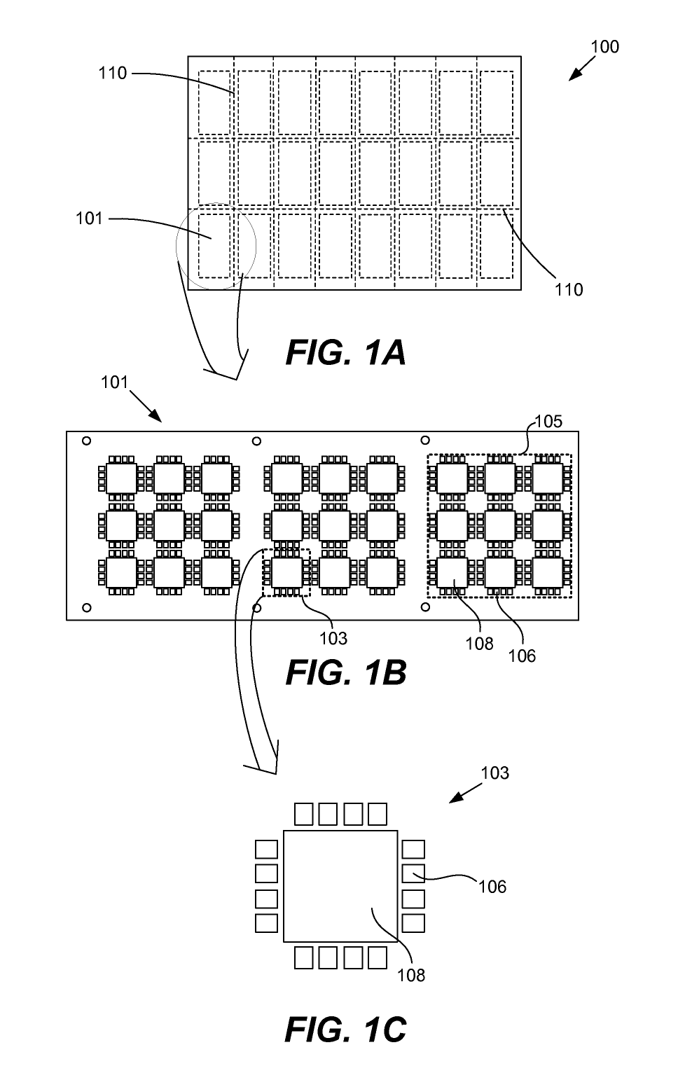

Referring first to FIGS. 1A-1C, an example substrate 100 adapted for high temperature processing according to one embodiment of the present invention is shown in partial top plan view. In various embodiments, substrate 100 may be formed of a thin flexible material. By way of example, substrate 100 may generally be comprised of an appropriate polymer such as a polyimide, a high temperature paper, or other suitable material that is able to withstand typical high temperature packaging processes. As will be appreciated by those of skill in the art, a typical die attach and cure process might run at 150° C. for 4 hours, a typical wire bonding process might run at 200° C. from 5 to 15 minutes depending upon the density of devices, and a typical encapsulant molding process might run at 175° C. for 5 minutes. In addition to being able to withstand the foregoing temperatures and times, substrate 100 may be formed from a material 101 to which one or more metallic layers may be readily applied. More specifically, one or more metallic electrical interconnect patterns will be deposited onto substrate 100 in an initial process phase. Substrate 100 will eventually be removed from the electrical interconnect patterns as portions of the pattern(s) are left exposed on the surfaces of finished packages at a later stage. Thus, substrate 100 may also be comprised of a material that is readily removable from the electrical interconnect pattern. Additionally, in embodiments in which the substrate is discarded after use, the substrate 100 may be formed of a low cost material.

In the illustrated embodiment, substrate 100 and the associated electrical interconnect pattern may be divided into a number of panels 101. FIG. 1B presents an enlarged top view of a panel 101 according to one embodiment of the invention. The electrical interconnect pattern associated with each panel 101 includes multiple device areas 103 formed through the deposition of one or more metallic layers, and which may be arranged into two-dimensional arrays 105. Each device area 103 is arranged to receive an associated integrated circuit die. In the illustrated embodiment, the footprint of each panel 101 and associated arrangements of two-dimensional arrays 105 resemble that of a typical leadframe panel. However, both the number of two-dimensional arrays 105 as well as the number and arrangement of the device areas 103 within each array may vary according to the type of end package desired.

FIG. 1C illustrates an enlarged top view of one of the device areas 103. Contact portions (hereinafter also referred to as contacts, leads or electrical interconnects) 106 form a pattern suitable for wirebonding or soldering to an integrated circuit die. In the illustrated embodiment, contact portions 106 are situated only on the periphery of device area 103. However, device area 103 may assume a wide variety of different patterns and configurations. Additionally, in some embodiments in which an associated die is to be wire-bonded to the contact portions 106, each device area 103 may include a die attach pad (DAP) 108 suitable for connection with the back surface of an associated integrated circuit die. Each device area 103 may even include multiple die attach pads for producing packages, such as SiP (system in package) packages, that include multiple dice or other pads for passive elements (e.g., resistors, capacitors and inductors for example). In general, the configuration of the contact portions 106 will depend upon the number of contacts required, package constraints, and whether the die is configured for wire-bonding or connection with solder joints as in flip-chip (FC) type packages.

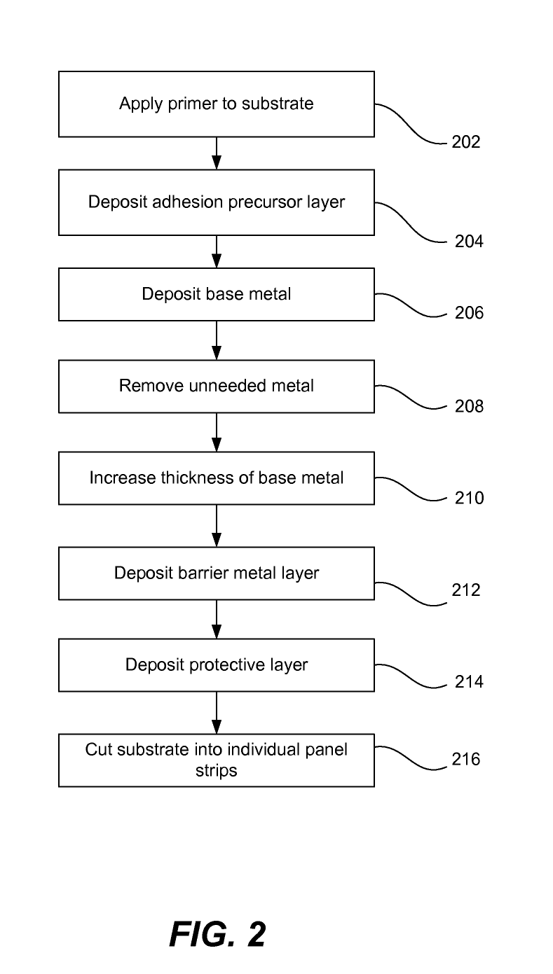

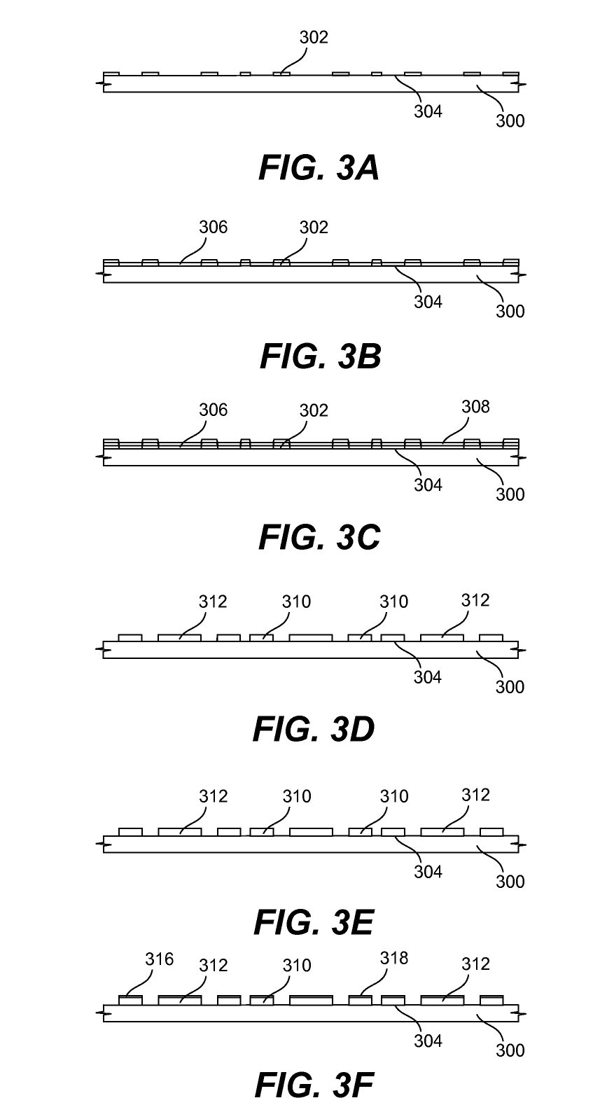

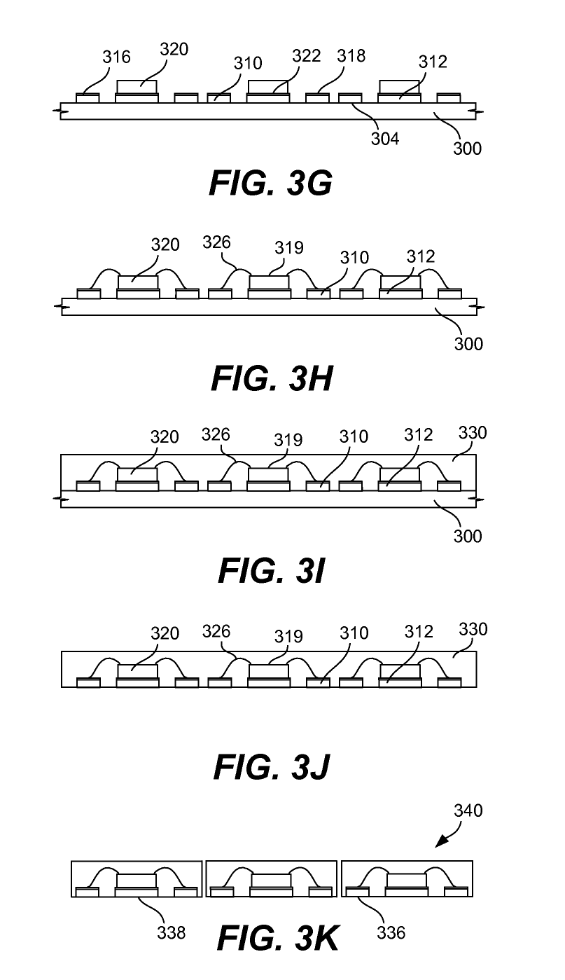

FIG. 2 shows a flowchart illustrating an example method for forming an electrical interconnect pattern on a substrate such as that described above with reference to FIGS. 1A-1C. FIGS. 3A-3F each illustrate a diagrammatic cross-section of a portion of an arrangement at various steps in the process of FIG. 2. First, a primer 302 is applied at 202 to a first surface 304 of a substrate 300 (such as substrate 100 of FIG. 1A) as illustrated in FIG. 3A. In one particular embodiment, the primer 302 is formed of a water-soluble ink. The primer 302 may be applied to the surface 304 with any suitable means. By way of example, primer 302 may be printed onto the first surface 304 of the substrate with a suitable printer (e.g., a screen, stencil or ink jet printer).

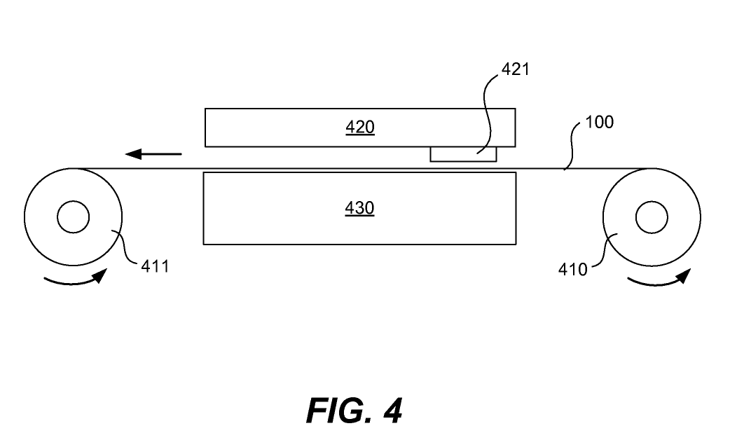

More specifically, in the embodiment illustrated in FIG. 4, the substrate 300 of FIG. 3A is shown going through a reel to reel printing process in side cross-sectional view. Substrate 300 may comprise a thin material that is rolled up to form an initial supply roll 410. Substrate 300 may be pulled off this supply roll and moved or otherwise processed past a printer 420 having a print head or other printing component 421. As substrate 300 passes by printer 420, the printing component 421 can print or otherwise dispense primer 302 into designed layouts for leadframe or other electrical interconnect patterns onto the substrate. More particularly, the primer 302 may be deposited so that selected areas on the surface 304 of the substrate 300 that are not covered with the primer 302 are arranged into a desired leadframe or other electrical interconnect pattern.

A platen 430 may be used to help guide and/or protect the thin substrate 300 as it passes through the printing process. In various embodiments, upon completion of the printing process, the printed substrate 300 is rolled up onto finishing roll 411. In some embodiments, platen 430 may be heated and/or include one or more alternative curing components coupled thereto, so as to facilitate a curing process for the freshly printed primer. Inkjet printer 420 may be selected from any of a number of commercially available or customized inkjet printers. In some embodiments, the setup shown in FIG. 4 may be arranged to work with many common off the shelf inkjet printers. Alternatively, a customized inkjet printer may be designed to work with a specific primer 302.

In some embodiments, an adhesion precursor layer 306 is deposited at 204 over the surface 304 of the substrate 300 including over those portions covered by the primer 302. In should be noted that in various embodiments, the substrate 300 is processed in rolled form as roll 411. Keeping the substrate 300 in rolled form may be cheaper and faster for many subsequent preparation and packaging processes (such as those described below). By way of example, currently available production equipment is capable of performing localized deposition in a reel to reel process. Specifically, in some embodiments a machine may be configured to clamp down on a large area of the substrate, apply a vacuum and allow metal sputtering.

The adhesion precursor layer 306 may be formed from any suitable material or materials including metals and metallic alloys and facilitates the adhesion of a later-applied metallic base layer to the substrate 300. More particularly, the material(s) utilized to form the adhesion precursor layer 306 will largely depend on the material(s) subsequently used to form a base metal layer. By way of example, the adhesion precursor layer 306 may be formed from Cr or TiW and may be deposited over the surface 304 in a sputtering process. It should be noted, however, that an adhesion precursor layer is not required in all embodiments.

Continuing to FIG. 3C, a base metal layer 308 is deposited at 206 over the surface of the substrate 300 including over those portions covered by the primer 302 (and over the adhesion precursor layer 306 if applicable). The base metal layer 308 may be formed from any suitable materials including those commonly used in leadframes (typically Cu) and bond pads (often Al), and may be deposited by means of any suitable process. In particular embodiments, an Al or Cu base metal layer 308 is sputtered onto the substrate 300. In alternate embodiments, the base metal layer 308 may be a metal stack including one or more Al or Cu layers as well as one or more barrier layers.

According to various embodiments, a suitable solvent is then used at 208 to clean the surface of the substrate 300 and remove the unneeded portions of the metal layers; that is, those metal portions directly over the primer 302. By way of example, in embodiments in which the primer 302 is water-soluble, a suitably pressurized water jet (around 200-300 psi in some embodiments for example) is used to remove the portions of the base metal layer 308 and adhesion precursor layer 306, as well as any other layers (in various embodiments there may be other layers deposited under or over the base metal layer), that are deposited over the primer 302. FIG. 3D illustrates substrate 300 and a portion of the electrical interconnect pattern formed from the portions of the base metal layer 308 not removed with the primer 302. In the illustrated embodiment, the resulting electrical interconnect pattern in each device area includes contacts 310 and a die attach pad 312.

Once the electrical interconnect pattern is defined, the thickness of the pattern (i.e., the thickness of the contacts 310 and die attach pads 312) may be increased at step 210 as illustrated in FIG. 3E. By way of example, the remaining portions of the base metal layer 308 may be selectively plated to increase the thickness. The plating may be accomplished by means of, for example, an electroless process, an electroplating process or even a printing process that deposits a conductive ink over the base metal layer 308. In the latter case, an inkjet printing process may utilize metallic nanoinks. Such metallic nanoinks can include conductive copper, silver and/or gold particles, and can be cured into a residual form such that substantially only these metal particles remain. In other embodiments, the thickness of the pattern may already be suitable for subsequent packaging processes. In various embodiments, it is desirable for the thickness of the base metal to be less than, by way of example, approximately 25 μm, and often less than 10 μm, and in some particular embodiments, in the range of approximately 0.5 to 2 μm, although other thicknesses are possible and permitted in other embodiments. It will be appreciated by those of skill in the art that a typical stamped or etched metal leadframe, in contrast, generally has a thickness on the order of 100 to 300 μm.

Depending on the type of electrical connections that will be used in connecting an associated die to the contacts 310, various other metal layers may be subsequently deposited over the base metal layer 308. By way of example, in some embodiments, particularly those in which solder joints will be used to physically and electrically connect bond pads on the die with associated contacts 310, one or more barrier metal layer(s) may be plated or otherwise deposited over the base metal layer 308 at 212. By way of example, such barrier metals may include Ni or Co as well as metal stacks such as NiPd stacks or NiPdAu stacks. The thickness of the barrier layer(S) may vary according to the type of package desired, however, thicknesses on the order of 1 μm or thinner work well in various embodiments.

Additionally, as shown in the embodiment illustrated in FIG. 3F, a protective layer 316 may be deposited at 214 over the base metal layer 308 and over any barrier metal layer(s). By way of example, a thin layer of Ag, Au or Pd or any other solder-wettable metal suitable for wire bonding and/or soldering may be flash deposited over the base metal layer 308. In various embodiments, the protective layer may have a thickness of less than 0.1 μm, for example. The exposed surface of the protective layer 316 on each contact 310 will be the bonding surface 318 for electrical connection with an associated die.

In alternate embodiments, the barrier metal layer(s) and protective layer 316 may be deposited over the base metal layer 308 prior to removal of the primer 302. In these embodiments, the unneeded portions of the barrier metal layer(s) and/or protective layer 316 are removed with the unneeded portions of the base metal layer 308. In this way, the surfaces of the contacts 310 may already be ready for electrical connection with bond pads on the associated die.

The substrate 300 is cut into individual strips or panels 301 (resembling panels 101 in various embodiments) at 216. By way of example, the substrate 300 may be sawed or otherwise cut along lines dividing individual panels such as lines 110 between panels 101 in FIG. 1.

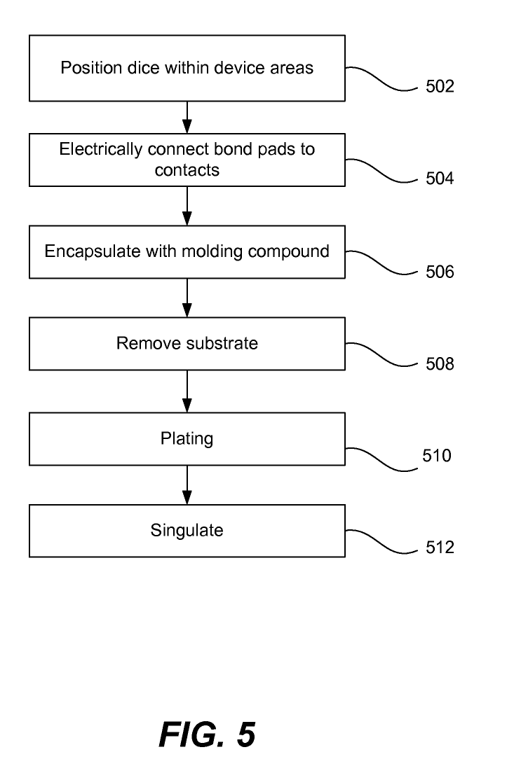

With reference to the flow chart of FIG. 5 and FIGS. 3G-3K, a process for packaging integrated circuit dice will be described. At 502, dice 320 are positioned within associated device areas. In the embodiment illustrated in FIG. 3G, the back surface 322 of each die 320 is physically attached to an associated die attach pad 312 by means of a suitable die attach material such as, by way of example, an epoxy or adhesive film. In embodiments in which die attach pads are not used, each die 320 may be positioned directly onto the substrate 300.

In the embodiment illustrated in FIG. 3H, bond pads on the active surfaces 319 of the dice are electrically connected at 504 to the contacts 310 by means of metallic (e.g., gold or copper) bonding wires 326. It should be noted that embodiments of the present invention are also well-suited for use in packaging dice that utilize solder joint connections. In these embodiments, each die may be inverted and the active surface of each die may be positioned directly adjacent the contacts 310 such that selected bond pads on the active surface of the die are positioned over corresponding contacts. Solder (in the form of solder balls, plated solder layers or solder paste, etc.) between the bond pads and the contacts 310 may then be reflowed to produce solder joint connections that physically and electrically connect the die 320 to the contacts 310.

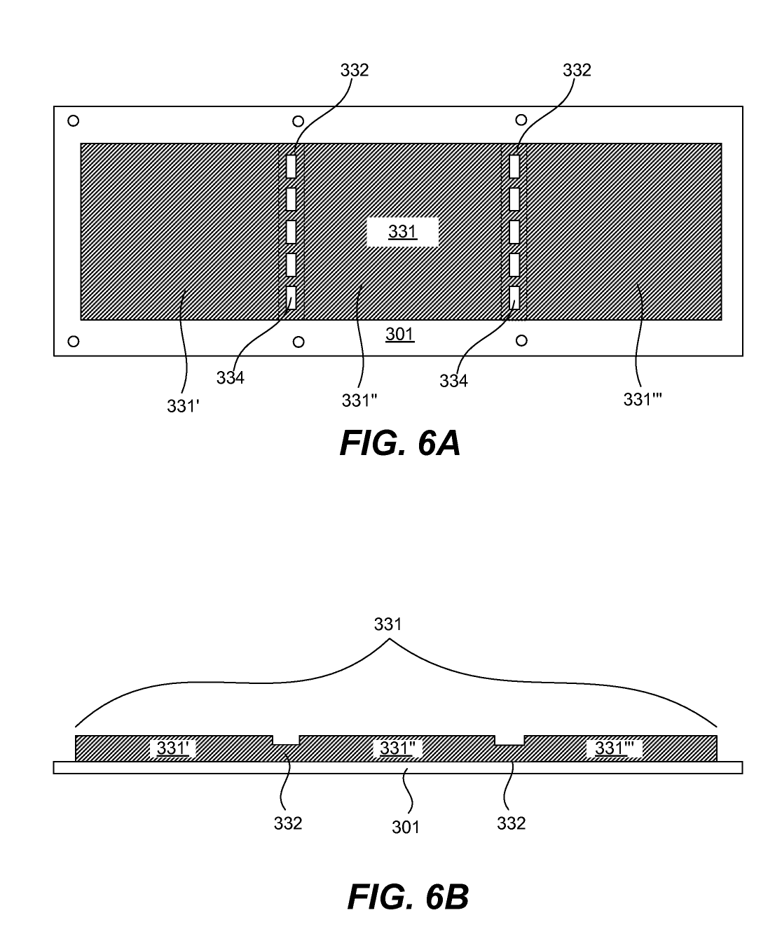

At 506 the electrical connections (e.g., bonding wires 326 or solder joints), dice 202, and portions of the contacts 310 and die attach pad 312 (if present) are encapsulated with a molding material (compound) 330 as illustrated in FIG. 3I. The molding compound 330 is generally a non-conductive plastic or resin having a low coefficient of thermal expansion. In a preferred embodiment, the entire populated cut substrate panel 301 is placed in the mold and encapsulated substantially simultaneously as shown in FIGS. 6A and 6B, illustrating top and side views, respectively. In another embodiment, the mold may be configured such that each two-dimensional array of device areas is encapsulated as a single unit. However, in particular embodiments, it is desirable to encapsulate the entire cut substrate panel with one molded cap 331 such that when the substrate 301 is later removed, the two-dimensional arrays of populated device areas remain fixed to one another. More specifically, although a typical leadframe panel does not have added molding material between separate device arrays, such a formation may be preferable in the present situation where the metallic interconnect pattern is too thin to have enough structural integrity to support itself. Accordingly, a single integral molded cap 331 may be formed that comprises each of the molded cap portions 331′, 331″ and 331′″ formed over the respective two-dimensional arrays of device areas. Such a single molded cap 331 provides support to the encapsulated device areas once the substrate panel 301 is removed.

However, since the molding material between the spaced regions 332 between device arrays primarily serves in order to provide support for panel level transport and processing, the amount of molding material in these regions may be reduced as compared to that which is desired for the more permanent encapsulated regions atop the packaged integrated circuit devices. As such, the thickness of the overall molded cap 331 in the regions 332 between device arrays can be less than the thickness of the molded cap over the actual device arrays, as shown in FIG. 6B. Furthermore, as shown in the embodiment illustrated in FIG. 6A, relief slots 334 may be incorporated into the molding compound 330 between the device areas. The relief slots 334 are essentially gaps or voids in the molding compound 330. Such relief slots 334 aid in relieving stresses present in the molded panel as a result of the encapsulation thereby reducing warpage of the panel. As will be appreciated, warpage of the encapsulated panel may lead to device damage including damage to the contacts and/or electrical connections. In some embodiments, a more unconventional or customized molding material that is resistant to warpage may also be used to encapsulate the panel. In other embodiments, the encapsulated strip may not include relief slots to ensure that a very robust strip is obtained. After encapsulation, the molding compound 330 may be cured in a heated oven (e.g., if the molding compound is a thermosetting plastic or other material that may require curing).

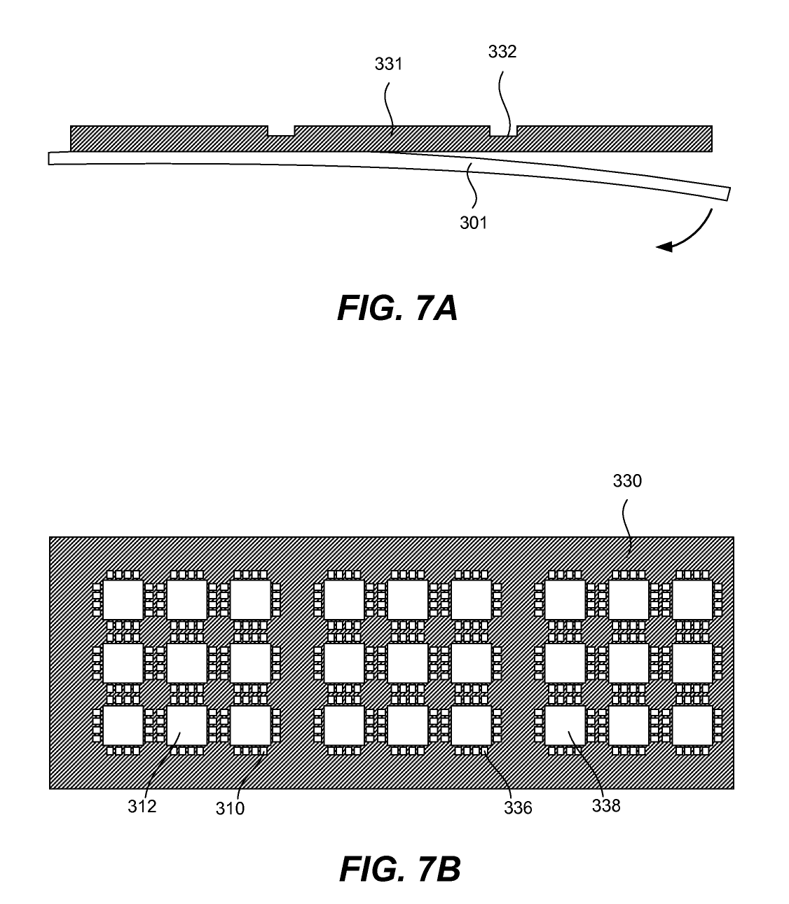

The substrate 300 may then be peeled off or otherwise removed at 508 to expose the contacts 310 and die attach pads 312 (where applicable) as shown in FIG. 3J. More specifically, FIG. 7A illustrates the molded strip of FIG. 6B having the thin substrate 301 being peeled away, and FIG. 7B depicts in bottom plan view the molded strip of FIG. 6A with the substrate removed and the electrical interconnect patterns exposed. As shown, the final removal of the substrate 301 results in the various contacts 310 and die attach pads 312 or other electrical interconnect patterns and components remaining connected with their respective dice or integrated circuit devices underneath. In various embodiments, the substrate may then be discarded.

After removal of the substrate 300, the bottom surfaces 336 of the contacts 310 (and in some embodiments the bottom surfaces 338 of the die attach pads if applicable) may be plated at 510 with Sn and/or solder to facilitate connection with corresponding contact surfaces on a printed circuit board (PCB) or other substrate.

In alternate embodiments, prior to the deposition of the base metal layer 308, an additional solder-wettable layer may be deposited over the substrate 300. The additional solder-wettable layer may be suitable for later connection with external contacts on a PCB or other substrate and may be comprised of similar materials as the protective layer 316 described above. Additionally, an additional barrier layer(s) may be deposited over the substrate 300 after depositing the solder-wettable layer just described and before depositing the base metal layer 308. This additional barrier layer may be comprised of similar materials as the barrier layer(s) described above. Uneeded portions of these additional layers would, of course, be removed with the primer as described above. In embodiments in which such a solder wettable layer and/or barrier layer are used, the plating at 510 may not be performed.

The encapsulated panel may then be singulated at 512 to yield a multiplicity of individual IC packages 340, such as that illustrated in FIG. 3K. The encapsulated panel may be singulated with any suitable means. By way of example, the panel may be singulated using sawing, gang-cutting (sawing), laser cutting or plasma cutting techniques. Those of skill in the art will recognize that the described methods may be used to produce a multitude of leadless leadframe package (LLP) or quad-flat-pack-no-lead (QFN) package formats. Additionally, for most embodiments, no new equipment is required and the processing largely follows a standard flow.

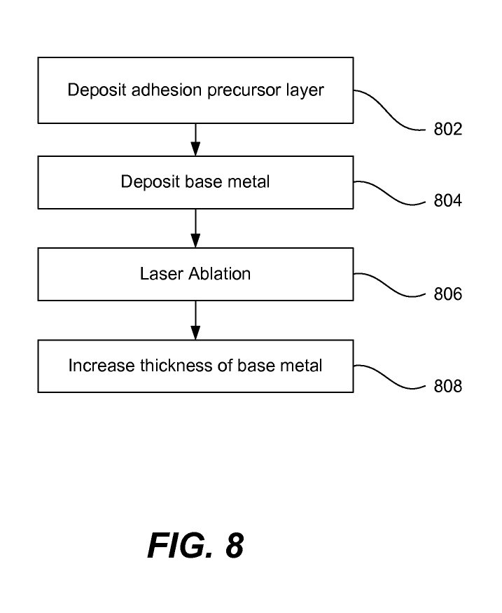

Another aspect of the invention will now be described with reference to the flow chart of FIG. 8. The process may begin at 802 with the optional sputtering or otherwise depositing of an adhesion precursor layer over the surface of a substrate such as substrate 300 described above. In contrast to the flowchart of FIG. 2, no primer is patterned over the substrate. At 804 a base metal layer is deposited over the substrate. In a particular embodiment, the base metal layer is deposited through a mask such that the resultant base metal layer forms a leadframe type pattern or other interconnect pattern. The base metal layer may either be a single metal layer (e.g., Cu) or a metal stack including base and barrier layers. The base metal layer may be sputtered onto the substrate (although other methods such as vapor deposition may be suitable), and in some embodiments, may have a thickness in the range of approximately 0.1 to 0.3 μm, although both thinner and thicker base metal layers may be desirable in various alternate embodiments.

The features of the interconnect pattern formed with the base layer are then sharpened using a laser ablation process at 806. During the laser ablation process, the base metal layer is irradiated with a laser beam. At low laser flux, the material is heated by the absorbed laser energy and evaporates or sublimates. At high laser flux, the material is typically converted to a plasma. Usually, laser ablation refers to removing material with a pulsed laser, but it is possible to ablate material with a continuous wave laser beam if the laser intensity is high enough. The use of laser ablation to sharpen the geometries of the interconnect pattern allows for the formation of very fine features. Furthermore, even finer features and pitches (e.g., ≦10 μm) may be produced by depositing the base metal layer without the use of a mask. In these embodiments, laser ablation alone may be used to form the interconnect pattern. After the interconnect pattern is defined, the thickness of the base metal layer may be increased at 808 and the process may then proceed as described above with reference to the flow charts of FIGS. 2 and 5.

The foregoing description, for purposes of explanation, used specific nomenclature to provide a thorough understanding of the invention. However, it will be apparent to one skilled in the art that the specific details are not required in order to practice the invention. Thus, the foregoing descriptions of specific embodiments of the present invention are presented for purposes of illustration and description. They are not intended to be exhaustive or to limit the invention to the precise forms disclosed. It will be apparent to one of ordinary skill in the art that many modifications and variations are possible in view of the above teachings. By way of example, it may be desirable to intentionally roughen the base layer 308 to ensure better adhesion with the molding compound 330. This may be accomplished via a mechanical and/or chemical process such as, for example, brown or black oxide treatments.

The embodiments were chosen and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents.

1. A method for forming an array of contacts for one or more integrated circuit devices, comprising:
depositing a primer onto a substrate such that first areas on the substrate are not covered by the primer, and wherein the first areas that are not covered by the primer form at least a first pattern;
depositing a base metal layer over the substrate;
removing the primer with a solvent, whereby first portions of the base metal layer that are deposited over the first areas of the substrate that are not deposited over primer are not removed with the primer and remain affixed with the substrate thereby forming an array of contacts, and whereby second portions of the base metal layer and any other portions of material that are deposited over primer are removed with the primer.

2. A method as recited in claim 1, further comprising sputtering an adhesion precursor layer over the substrate after depositing the primer and prior to depositing the base metal layer, wherein first portions of the adhesion precursor layer that are deposited over the first areas of the substrate are not removed with the primer and second portions of the adhesion precursor overlying the primer are removed with the primer such that the first portions of the base metal layer that are deposited over the first portions of the adhesion precursor layer remain affixed with the substrate by means of the adhesion precursor layer after removal of the primer.

3. A method as recited in claim 1, wherein the thickness of the base metal layer is less than approximately 10 microns.

4. A method as recited in claim 1, further comprising selectively plating portions of the base metal layer to increase the thickness of the base metal layer, wherein the selective plating is accomplished by one of the group consisting of an electroless process, an electroplating process and a printing process that deposits a conductive ink over the first portions of the base metal layer.

5. A method as recited in claim 1, wherein the substrate is formed from a polymeric material or a high-temperature rated paper.

6. A method as recited in claim 1, wherein the substrate is unrolled from a first reel prior to depositing the primer and subsequently re-rolled onto a second reel after depositing the primer in a reel-to-reel process.

7. A method as recited in claim 1, wherein the primer is printed onto the substrate.

8. A method as recited in claim 1, wherein the primer is water-soluble and the solvent comprises water.

9. A method as recited in claim 1, wherein the first areas that form the first pattern are patterned into at least one leadframe panel pattern including at least one array of device areas, and wherein each device area is patterned into a leadless leadframe type pattern having an array of contacts.

10. A method as recited in claim 9, further comprising cutting the substrate into panels, each panel having a conventional leadframe panel footprint, wherein each panel includes at least one array of devices areas.

11. A method as recited in claim 9, further comprising attaching and electrically connecting a plurality of dice to the at least one array of device areas such that each die is positioned within an associated device area.

12. A method as recited in claim 11, wherein each device area further includes a die attach pad patterned from the base metal layer such that the array of contacts within the associated device area circumferentially surround the associated die attach pad, and wherein a back surface of each die is positioned over an associated die attach pad.

13. A method as recited in claim 11, wherein bonding wires are utilized to electrically connect I/O pads on the active surfaces of the dice with associated contacts from the associated device area.

14. A method as recited in claim 14, wherein the active surface of each die includes a plurality of I/O pads and wherein each I/O pad is positioned over an associated contact, the method further comprising reflowing solder between the I/O pads and associated contacts to physically and electrically connect the die to the associated contacts.

15. A method as recited in claim 11, further comprising
encapsulating the at least one array of device areas on a strip with molding material including at least portions of the dice and contacts;
removing the substrate after the encapsulation while leaving at least the base metal layer affixed with the molding material thereby leaving at least bottom surfaces of the contacts exposed; and
singulating the at least one array of device areas to provide a multiplicity of individual integrated circuit packages.

16. A method as recited in claim 1, further comprising depositing a solder-wettable layer prior to depositing the base metal layer, the solder-wettable layer being suitable for connection with external contacts.

17. A method as recited in claim 16, further comprising depositing a barrier layer after depositing the solder-wettable layer and before depositing the base metal layer.

18. A method for forming an array of contacts for one or more integrated circuit devices, comprising:
depositing a base metal layer over a substrate;
using laser ablation on the base metal layer to define an array of contacts formed from the base metal layer;
selectively plating portions of the base metal layer after using laser ablation to increase the thickness of the array of contacts.

19. A method as recited in claim 18, wherein the base metal layer is sputtered through a mask to roughly define the array of contacts and wherein laser ablation is used to sharpen the geometries of the contacts.

20. A method as recited in claim 18, wherein the thickness of the base metal layer before using laser ablation is in the range of approximately 0.1 to 0.3 microns.

21. A method as recited in claim 18, further comprising sputtering an adhesion precursor layer over the substrate prior to depositing the base metal layer.

22. A method as recited in claim 18, wherein the selective plating is accomplished by one of the group consisting of an electroless process, an electroplating process and a printing process that deposits a conductive ink over the first portions of the base metal layer.

23. A method as recited in claim 18, further comprising depositing a protective layer over the base metal layer after plating the base metal layer.

24. A method as recited in claim 23, further comprising depositing a barrier layer over the base metal layer prior to depositing the protective layer.

25. A method as recited in claim 18, wherein the base metal layer is patterned into at least one leadframe panel pattern including at least one array of device areas, and wherein each device area is patterned into a leadless leadframe type pattern having an associated array of contacts.

26. A method as recited in claim 25, further comprising cutting the substrate into panels, each panel having a conventional leadframe panel footprint, wherein each panel includes at least one array of devices areas.

27. A method as recited in claim 25, further comprising attaching and electrically connecting a plurality of dice to the at least one array of device areas such that each die is positioned within an associated device area.

28. A method as recited in claim 27, wherein each device area further includes a die attach pad patterned from the base metal layer such that the array of contacts within the associated device area circumferentially surround the associated die attach pad, and wherein a back surface of each die is positioned over an associated die attach pad.

29. A method as recited in claim 27, wherein bonding wires are utilized to electrically connect I/O pads on the active surfaces of the dice with associated contacts from the associated device area.

30. A method as recited in claim 27, wherein the active surface of each die includes a plurality of I/O pads and wherein each I/O pad is positioned over an associated contact, the method further comprising reflowing solder between the I/O pads and associated contacts to physically and electrically connect the die to the associated contacts.

31. A method as recited in claim 27, further comprising
encapsulating the at least one array of device areas on a strip with molding material including at least portions of the dice and contacts;
removing the substrate after the encapsulation while leaving at least the base metal layer affixed with the molding material thereby leaving at least bottom surfaces of the contacts exposed; and
singulating the at least one array of device areas to provide a multiplicity of individual integrated circuit packages.
